(19) United States
(12) Patent Application Publication
(10) Pub. No.: US 2016/0370856 A1
(43) Pub. Date: Dec. 22, 2016

(54) ELECTRONIC DEVICE AND VIRTUAL RETINAL DISPLAY HAVING THE ELECTRONIC DEVICE

(71) Applicant: HON HAI PRECISION INDUSTRY CO., LTD., New Taipei (TW)

(72) Inventor: JEN-TSORNG CHANG, Tu-Cheng (TW)

(21) Appl. No.: 14/834,701

(22) Filed: Aug. 25, 2015

(30) Foreign Application Priority Data
Jun. 22, 2015 (CN) 201510344055.9

(51) Int. Cl. G06F 3/01; G06F 3/16; A63F 9/24; A63F 13/235; A63F 13/25; G06F 3/02; A63F 13/24

(52) U.S. Cl. CPC G06F 3/011; G06F 3/0202; G06F 3/16; A63F 13/24; A63F 13/235; A63F 13/25; A63F 9/24; A63F 2009/2475

(57) ABSTRACT

A virtual retinal display device includes a mounting frame for mounting on a user's head. A slot is formed in a front end of the mounting frame for receiving a main body an electronic device which has an electrical connector mating with an electrical connector formed in the slot. Images generated by the main body can be transmitted to a user's retinas through a lens module fixed to the mounting frame. The electronic device furthers has a transceiver and a controller electrically connected with the transceiver through mated electrical connectors. Commands generated by manipulating the controller are transmitted to the main body to control operations thereof through the transceiver. The main body is electrically connectable with the controller when the main body is not received in the slot.

### CROSS-REFERENCE TO RELATED APPLICATIONS

This application claims priority to China Patent Application No. 201510344055.9 filed on Jun. 22, 2015, the contents of which are incorporated by reference herein.

### FIELD

The subject matter herein generally relates to an electronic device and a virtual retinal display for accommodating the electronic device, and particularly to a handheld electronic device and a virtual retinal display for accommodating the handheld electronic device.

### BACKGROUND

An electronic device, such as a game gadget, includes a display unit and a game control unit having a plurality of buttons. By operating the buttons, a user can play a game shown on the display unit. The control unit and the display unit of the game gadget are formed together as a monolithic piece.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a diagrammatic, exploded view of an electronic device in accordance with a first embodiment of the present disclosure.

FIG. 2 is a block diagram of a circuitry in a main body of the electronic device of FIG. 1.

FIG. 3 is a diagrammatic, isometric view showing a virtual retinal display (VRD) for an electronic device in accordance with a second embodiment of the present disclosure, the VRD being worn by a user.

FIG. 4 is a diagrammatic, exploded view of a part of the electronic device in accordance with the second embodiment of the present disclosure.

FIG. 5 is a diagrammatic, exploded view of a part of the VRD and a main body of the electronic device of FIG. 3, viewed from another angle.

FIG. 6 is a diagrammatic, isomeric view of a part of the VRD of FIG. 3, viewed from still another angle.

FIG. 7 is a diagrammatic, assembled view of FIG. 5, viewed from a different angle.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

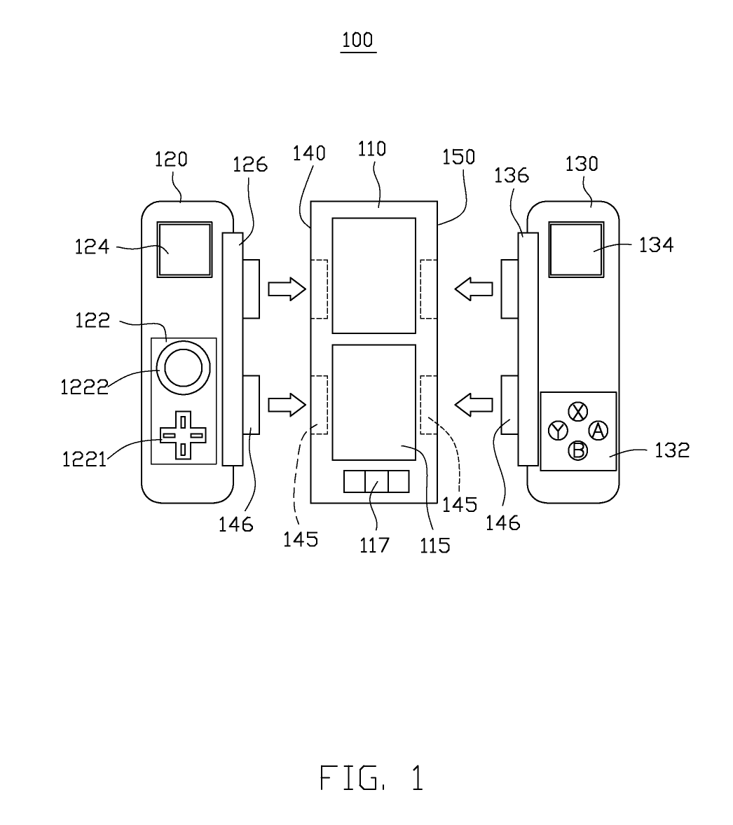

Referring to FIG. 1, an electronic device 100 includes a main body 110, a first controller 120 and a second controller 130, wherein the first and second controllers 120, 130 are separably connectable with the main body 110. In the illustrated embodiment, the electronic device 100 is a game gadget having Internet connection and communication capability. It can be understood that in an alternative embodiment, the electronic device 100 can be a mobile phone or other handheld electronic devices.

The main body 110 has a first side 140 forming two first electrical connectors 145 therein and an opposite second side 150 also forming two first electrical connectors 145 therein. Each of the first electrical connectors 145 is a receptacle connector. A display unit 115 is formed on a top face of the main body 110. An operating unit 117 is formed on the top face and located below the display unit 115 of the main body 110.

The first controller 120 includes a first speaker 124 in a top face thereof, a first button group 122 in the top face thereof and below the first speaker 124 and a first side 126 forming two second electrical connectors 146 thereon. The second controller 130 includes a second speaker 134 in a top face thereof, a second button group 132 in the top face thereof and below the second speaker 134 and a first side 136 forming two second connectors 146 thereon. Each of the two second connectors 146 is a plug connector. In an alternative embodiment, there can be only one electrical connector in each of the two opposite first and second sides 140, 150 of the main body 110, and on each of the first sides 126, 136 of the first and second controllers 120, 130. Moreover, the first electrical connectors 145 for the main body 110 can be plug connectors while the second electrical connectors 146 for the first and second controllers 120, 130 can be receptacle connectors.

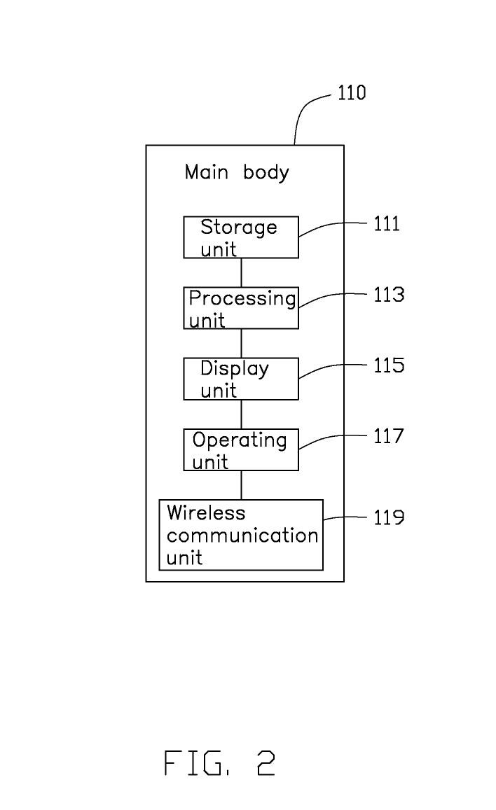

FIG. 2 illustrates the main body 110 of the electronic device 100 includes a storage unit 111, a processing unit 113, the display unit 115, the operating unit 117 and a wireless communication unit 119. The storage unit 111 is provided for storing electronic files and audio/video information therein. The storage unit 111 can include random-access memory (RAM) and flash memory. The processing unit 113 which is a central processing unit (CPU) can be electrically coupled with the first and second controllers 120, 230 through the first electrical connectors 145 and the second electrical connectors 146 when they are connected together. Thus, the processing unit 113 can receive commands from the first and second controllers 120, 130.

The display unit 115 includes at least one liquid crystal display (LCD). In the illustrated embodiment, the display unit 115 includes two LCDs. The display unit 115 is provided for displaying video and picture information, electronic files and command information from the first and/or second controllers 120, 130. The operating unit 117 which includes control circuits controls main operations of the electronic device 100, such as turn-on/turn-off volume adjustment and display brightness adjustment of the electronic device 100.

The wireless communication unit 119 includes at least one of following wireless communication capabilities: Bluetooth, Near-Field Communication (NFC), Global System for Mobile Communications (GSM), General Packet Radio Service (GPRS), Code Division Multiple Access (CDMA) and Long Term Evolution (LTE). The electronic device 100 can communicate with Internet websites, multimedia equipments having wireless communication capability or other wireless devices to obtain information therefrom through the wireless communication unit 119.

The first button group 122 can include a directional pad 1221 and an enter button 1222 above the directional pad 1221. The second button group 132 can include ABXY buttons. By manipulating these buttons the user can conveniently and easily control the operations of the electronic device 100 and play the games executed by the electronic device 100. The first and second speakers 124, 134 are used for broadcasting the audio information of the electronic device 100 such as sounds of a video clip or a game.

In operation, the first electrical connectors 145 are electrically coupled with the second electrical connectors 146 by inserting the second electrical connectors 146 into the first electrical connectors 145. Then by controlling the operations of the operating unit 117 and the first and second button groups 122, 132, the user can watch required information or play a desired game shown on the display unit 115.

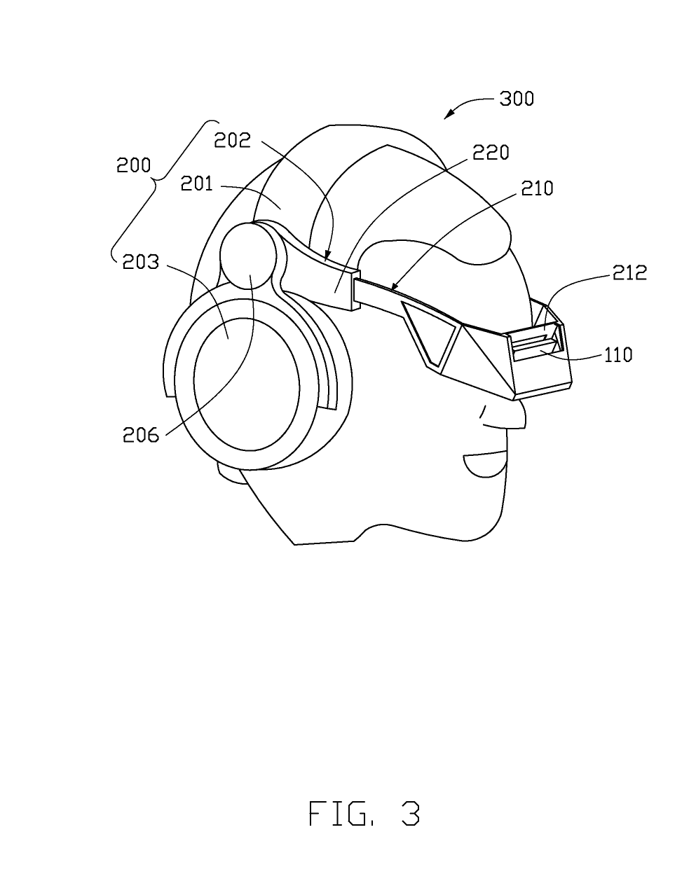

FIG. 3 illustrates a virtual retinal display 300 which includes a mounting frame 200. The mounting frame 200 includes a head-wearing portion 201, a bearing portion 202 and an audio output portion 203. The head-wearing portion 201 has a structure like a headband of a headphone and is arc-shaped for matching a profile of the user's head whereby the virtual retinal display 300 can be comfortably worn on the user's head. The audio output portion 203 is formed at a free, bottom end of the head-wearing portion 201 and includes right and left earphones (only one shown). The audio output portion 203 is fixedly connected to the head-wearing portion 201. The bearing portion 202 extends forwardly from two hinges 206 (only one shown) formed at tops of the earphones whereby the bearing portion 202 can pivot relative to the earphones. Thus when the virtual retinal display 300 is not in use, the bearing portion 202 can be folded into a retracted position to thereby save occupying space of the virtual retinal display 300. The bearing portion 202 includes two supports 220 (only one shown) connecting with the hinges 206 and the head-wearing portion 201, and a carrier 210 having a portion slidably received in the supports 220 and extending forwardly therefrom. The carrier 201 forms an accommodating slot 212 at a front free end thereof. The main body 110 of the electronic device 100 in accordance with a second embodiment of the present disclosure is received in the slot 212 when the electronic device 100 is used in connection with the virtual retinal display 300.

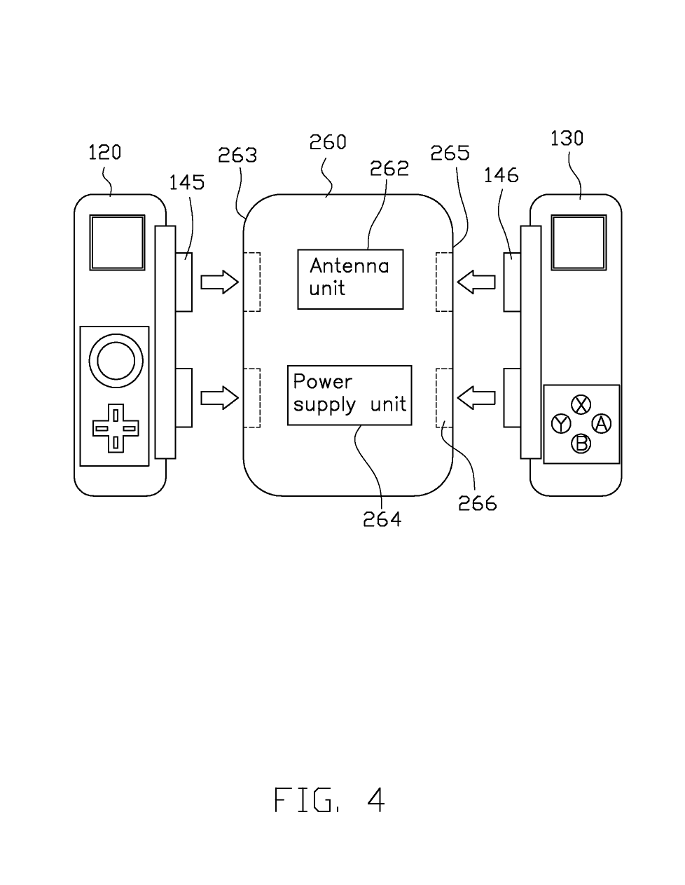

FIG. 4 illustrates the electronic device 100 in accordance with the second embodiment of the present disclosure. In addition to the main body 110 and first and second controllers 120, 130 of the first embodiment, the second embodiment further includes a wireless signal transceiver 260. The wireless signal transceiver 260 includes an antenna unit 262 for transmitting/receiving wireless signals to/from the main body 110 and a power supply unit 264 for supplying required power to the antenna unit 262 and the first and second controllers 120, 130. The wireless signal transceiver 260 includes opposite first and second sides 263, 265 each forming two third electrical connectors 266 therein. Each third electrical connector 266 is a receptacle connector and has a configuration substantially the same as that the first electrical connector 245.

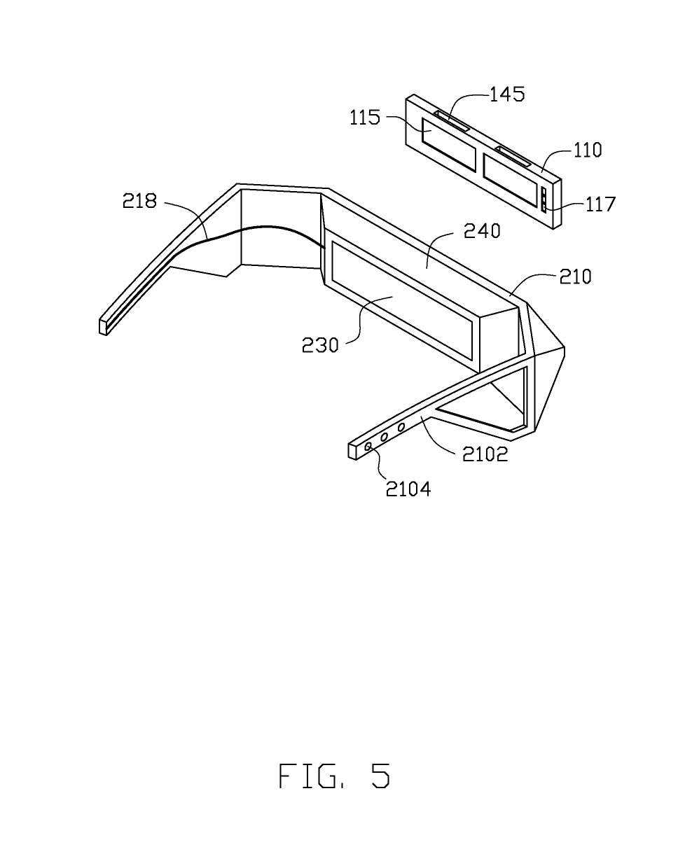

FIG. 5 illustrates the carrier 210 which has a configuration like a pair of glasses includes two temples 2102 for slidably engaging in the supports 220. Each temple 2102 forms three protrusions 2104 thereon, a selected one of which can engage in a notch (not shown) defined in a corresponding support 220 whereby a length of the temples 2012 extending out of the supports 220 can be adjusted to match a distance between the nose and the ears of the user. In the rear side of the carrier 210, a lens module 230 and a shield 240 are formed. The lens module 230 is used for transmitting images shown by the display unit 115 of the main body 110 of the electronic device 100 into retinas of the user and can include a plurality lenses. The shield 240 which surrounds the lens module 230 and extends from the lens module 230 toward the front end of the carrier 210 is used for preventing environmental light from entering the user's eyes. Two electrical wires 218 (only one shown) extend from a front end of the carrier 210 rearwards to electrically connect with the audio output portion 203 (FIG. 2).

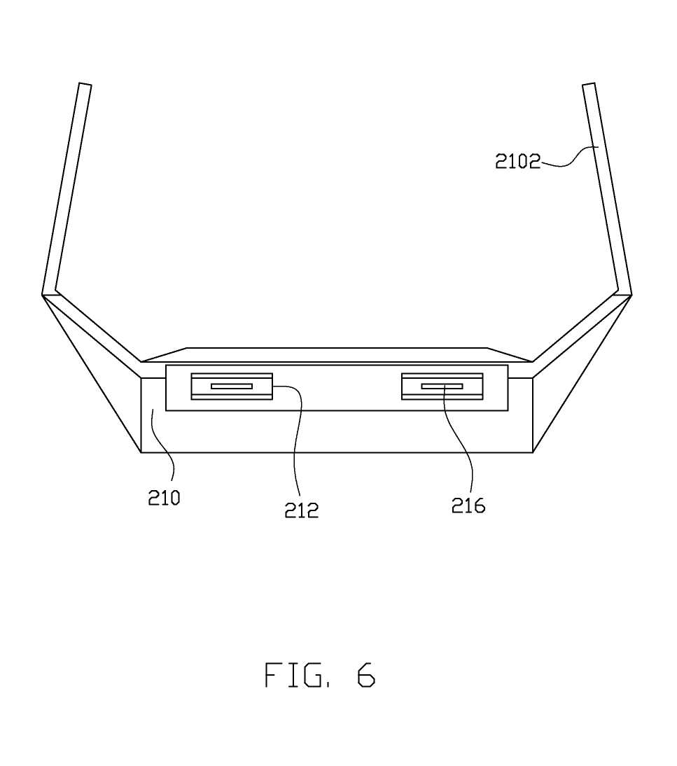

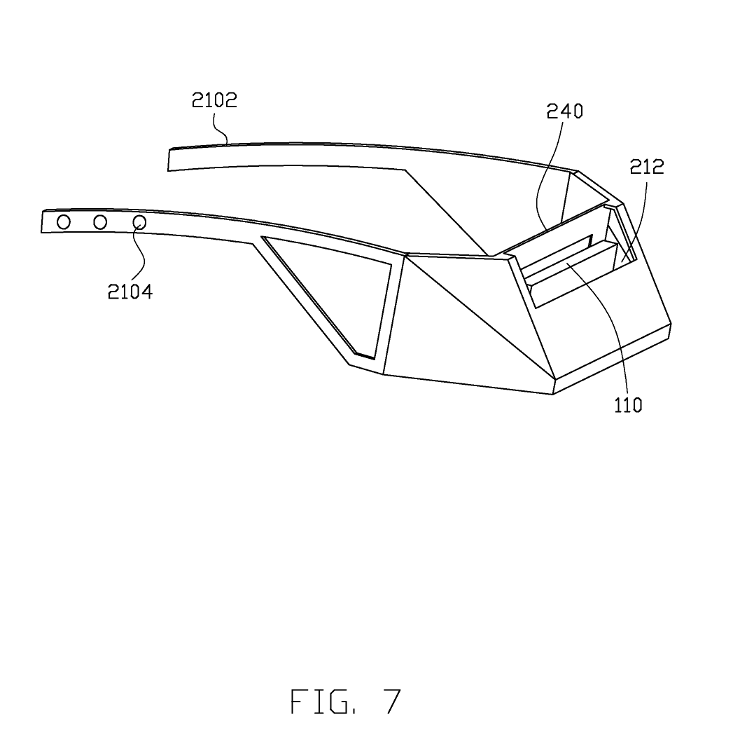

FIG. 6 illustrates the front side of the carrier 210 forming a slot 212. Two fourth electrical connectors 216 are formed in a bottom of the slot 212, wherein each of the fourth electrical connectors 216 in accordance with the present embodiment is a plug connector and has a configuration substantially the same as that of the second electrical connector 146. The electrical wires 218 are in electrical connection with the fourth connectors 216. Also referring to FIGS. 5 and 7, when the main body 110 is received in the slot 212, the main body 110 is horizontally oriented with the display unit 115 and the operating unit 117 facing rearwards toward the lens module 230. Two first electrical connectors 145 are electrically mated with the two fourth electrical connectors 216 whereby audio information generated by the main body 110 can be transmitted to the audio output portion 203 through the electrical wires 218. An image generated by the main body 110 and shown by the display unit 115 can be transmitted to the user's retinas through the lens module 230 whereby the user can see an enlarged virtual image floating in a space in front of the user.

To use the virtual retinal display 300, also referring back to FIG. 4, the first and second controllers 120, 130 are electrically coupled with the wireless signal transceiver 260. The user holds the controllers 120, 130 and the transceiver 260 in combination by hands. Commands generated by pressing the first and second button groups 122, 132 of the first and second controllers 120, 130 are transmitted to the processing unit 113 of the main body 110 through the antenna unit 262 and the wireless communication unit 119, whereby the user can play a game executed by the main body 110 and displayed by the virtual retinal display 300. The user can hear the sounds of the game through the earphones of the audio output portion 203 which electrically connect with the main body 110 through the electrical wires 218, the fourth electrical connectors 216 and the first electrical connectors 145. Furthermore, the user can see the images of the game through the lens module 230 and the display unit 115 of the main body 110.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A virtual retinal display device comprising:
a mounting frame configured for mounting on a user's head and having a slot, at least one first electrical connector formed in the slot and a lens module; and
an electronic device having:
a main body received in the slot and having at least one second electrical connector mating with the at least one first electrical connector,
a transceiver having at least one third electrical connector, and
at least one controller having at least one fourth electrical connector mating with the at least one third electrical connector;
wherein an image generated by the main body is configured to be transmitted to the user's retina through the lens module and commands, for controlling operations of the main body, generated by manipulating the at least one controller are transmitted to the main body through the transceiver.

2. The virtual retinal display device of claim 1, further comprising an audio output portion connected to the mounting frame and electrically coupling with the main body through the at least one first electrical connector, the at least one second electrical connector and electrical wires connecting the at least one first electrical connector and the audio output portion, wherein the main body has a display unit facing the lens module.

3. The virtual retinal display device of claim 2, wherein the at least one controller has buttons formed thereon, the commands being generated by pressing the buttons.

4. The virtual retinal display device of claim 3, wherein the at least one fourth electrical connector of the at least one controller is connectable with the at least one second electrical connector of the main body and wherein when the at least one fourth and at least one second electrical connectors are mated together, the commands generated by manipulating the at least one controller are sent the main body through the mated at least one fourth and at least one second electrical connectors.

5. The virtual retinal display device of claim 4, where the at least one controller comprises two controllers each having at least one fourth electrical connector, the at least one second electrical connector includes at least two second electrical connectors each formed in a side of the main body, the at least one fourth electrical connector being connectable with a corresponding one of the at least two second electrical connectors.

6. The virtual retinal display device of claim 3, wherein the at least one controller comprises two controllers each having at least one fourth electrical connector, the at least one third electrical connector includes at least two third electrical connectors each formed in a side of the transceiver, the at least one fourth electrical connector being mated with a corresponding one of the at least two third electrical connectors.

7. The virtual retinal display device of claim 6, wherein the two controllers have two button groups formed thereon, respectively.

8. The virtual retinal display device of claim 3, wherein the mounting frame comprises a head-wearing portion having an arced shape, a bearing portion and a carrier forming the slot and the lens module, the audio output portion having at least one earphone being formed at a free bottom end of the head-wearing portion, the bearing portion being pivotably connected to the audio output portion, the carrier being slideably connected to the bearing portion, whereby a distance of the carrier extending out of the bearing portion is adjustable.

9. The virtual retinal device of claim 8, wherein the carrier forms a shield surrounding the lens module and extending forward from the lens module, configured for preventing environmental light from entering the user's eyes.

10. A game gadget comprising:
a main body comprising a display unit for showing an image generated by the main body, a processing unit and at least one first electrical connector; and
at least one controller having at least one second electrical connector mating with the at least one first electrical connector;
wherein commands for controlling operation of the main body and generated by manipulating the at least one controller are transmitted to the main body to be processed by the processing unit through the mated at least one first and second electrical connectors.

11. The game gadget of claim 10, further comprising a virtual retinal display having a frame forming a slot, at least one third electrical connector in the slot and a lens module, wherein when the main body is separated from the at least one controller and put into the slot to have the at least one first electrical connector mating with the at least one third electrical connector, an image shown by the display unit being transmittable to a user's retina through the lens module.

12. The game gadget of claim 11, further comprising a transceiver and wherein when the main body is mounted in the slot, the at least one controller is connectable with the transceiver, the commands for controlling operations of the main body and generated by manipulating the at least one controller being wirelessly sent to the main body through the transceiver, the transceiver having at least one fourth electrical connector mating with the at least one second electrical connector of the at least one controller.

13. The game gadget of claim 12, wherein the main body has a wireless communication unit for receiving the commands from the transceiver.

14. The game gadget of claim 11, wherein the virtual retinal display has an audio output portion in electrical connection with the main body to receive audio information therefrom through the mated at least one first and third electrical connectors and at least one electrical wire electrically connecting the audio output portion and the at least one third electrical connector.

15. The game gadget of claim 14, wherein the audio output portion includes at least one earphone.
